(19) United States
(12) Patent Application Publication
(10) Pub. No.: US 2011/0013976 A1
(43) Pub. Date: Jan. 20, 2011

(54) Beam and column connector

(76) Inventor: Anthony N. Konstant, Winnetka, IL (US)

Correspondence Address: Michael S. Leonard;EVEREST INTELLECTUAL PROPERTY LAW GROUP, P.O. Box 708, Northbrook, IL, 60065, US

(21) Appl. No.: 12/460,268

(22) Filed: Jul. 16, 2009

(51) Int. Cl. F16B 7/00; F16B 9/00; B21D 47/00

(52) U.S. Cl. 403/187; 29/897

(57) ABSTRACT

A beam and column connector connects a beam to a column in structural support systems, such as storage racks. The beam and column connector has a body portion which is securely connected to the end of the beam. The body portion of the beam and column connector has a shape which conforms to the shape of the beam. The beam and column connector also has a column mounting portion which extends from the body portion. The column mounting portion allows the beam and column connector to be securely connected to the column. The beam and column connector can be used with a wide variety of beams and columns. The beam and column connector can provide a strong and safe connection between the beam and the column.

### BACKGROUND OF THE INVENTION

This invention relates to structural support systems, such as structural storage racks. More specifically, this invention relates to the connection between a beam and a column of a structural support system. Embodiments of the present invention provide a beam and column connector which connects the beam to the column in a structural support system. The present invention also pertains to related methods, including methods of making beam and column connectors, methods of connecting a beam and a column together, and methods of assembling structural support systems. At least one preferred embodiment of the present invention is described in the context of a beam and column connector for a storage rack. However, the present invention is not limited to a preferred embodiment and may be practiced in other embodiments, as well.

Structural storage racks are well known and commonly used in warehouses to store items. Existing structural storage racks can have four vertical columns arranged in a rectangular pattern. Horizontal beams are connected to the columns at opposite ends of each beam. The opposite ends of the beams are bolted to their respective columns. The bolted beam to column connection allows for the storage rack to be disassembled, if desired. The beams form shelves or supports for shelves to support and store items on the rack. The beam to column connection is one of the most important connections in the storage rack. The beam to column connection provides vertical support for the rack by transferring the beam loads to the columns. Also, the beam to column connection provides lateral support and stability for the rack. The importance of the beam to column connection in storage racks is one reason to provide new and improved beam to column connections.

The inventor of the present invention is also an inventor of the inventions in various published patent applications and issued patents pertaining to structural storage racks. See, for example, U.S. Patent Application Publication Nos. US 2009/0107943 A1, US 2007/0193190 A1, US 2007/0175846 A1, US 2006/0163185 A1 and others, and U.S. Pat. Nos. 6,691,880, 6,497,332, 5,310,066, 4,678,091, 3,679,067 and others.

One of the patents just mentioned is U.S. Pat. No. 4,678,091 to Konstant et al., which issued on Jul. 7, 1987 (“Konstant et al.”). Konstant et al. pertains to a beam to column connection, for example, in a storage rack. The beam to column connection of Konstant et al. has proven to be very successful for many years. However, there are needs for new beam to column connections. The beam to column connection of Konstant et al. is particularly useful for columns and beams made of hot-rolled structural channels and I-beam shapes. The ends of the beams in Konstant et al. must be cut to form an end flange that overlaps the column. The cut end flange of the beam is bolted to the column. Beams may have cross-sectional shapes which can make cutting the end of the beam to form the end flange difficult. Accordingly, the beam to column connection of Konstant et al. is somewhat limited to the type of beams that it can be used with.

Also, beams have had an angle section welded to the end of the beam for bolting to the column. The angle section has an inside corner which has a radius. Columns generally have an outside corner which is square. When the beam/angle section inside corner a having a radius meets the column outside square corner, the connection may not be as tight and strong as desired. Accordingly, the beam to column connection can be improved.

Thus, needs exist for new beam to column connections in structural support systems, for the reasons mentioned above and for other reasons. It would be an improvement to provide a new beam and column connector for structural support systems in which the connector connects the beam and the column together.

### SUMMARY OF THE INVENTION

The present invention provides new beam and column connectors which connect beams to columns having square corners in structural support systems, such as storage racks. The beam and column connector has a body portion which is securely connected to the end of the beam. The body portion of the beam and column connector has a shape which conforms to the shape of the beam for easy, strong and secure attachment to the end of the beam. The beam and column connector also has a mounting web which extends from the body portion. The mounting web allows the beam and column connector to be securely connected to the column without a radius interfering with a square corner of the column. The beam and column connector can be used with a wide variety of beams and columns. Also, the beam and column connector is easy to manufacture and inexpensive. The beam and column connector can provide a stronger and safer connection between the beam and column. The present invention is described in an embodiment of a beam and column connector for use in a storage rack. However, the present invention is broader than beam and column connectors for storage racks and is not limited to beam and column connectors for storage racks.

In an embodiment of the present invention, a structural support system has an upward extending column and a beam having an end adjacent the column. A beam and column connector has a body portion having a non-planer shape conforming to and attached to a non-planer surface of the end of the beam. A column mounting portion extends from the body portion and is connected to the column.

The body portion of the beam and column connector can be welded to the end of the beam. The column mounting portion of the beam and column connector can be a web having one or more bolt holes. The beam and column connector can be bolted to the column.

The body portion of the beam and column connector can have a shape which has at least two non co-planer surfaces which conform to and connect to either an outer surface of the end of the beam or an inner surface of the beam.

The column mounting portion can have a width about the same as a cross-sectional width of the beam.

The column mounting portion can have a width greater than a cross-sectional width of the beam.

The body portion of the beam and column connector can have a width adjacent the column mounting portion which is wider than the cross-sectional width of the beam, and the width of the body portion can narrow at an end opposite the column mounting portion.

The body portion of the beam and column connector can have a base portion having first and second opposed edges, a first tab portion extending from the first edge of the base portion at an angle to the base portion, and a second tab portion extending from the second edge of the base portion at an angle to the base portion. The first and second tab portions may not be parallel to each other.

In an embodiment of the structural support system, the end of the beam can be a first end and the beam can have a second end opposite the first end. The column can be a first column. The structural support system may further have another beam and column connector having a body portion attached to the second end of the beam and a column mounting portion extending from the body portion and connected to another column spaced away from the first column.

The body portion of each beam and column connector can be welded to its respective first or second end of the beam. The column mounting portion of each beam and column connector can be a web having a bolt hole and can be bolted to its respective first or second column.

In another embodiment of the present invention, a beam and column connector for a structural support system has a body portion having a non-planer surface adapted to attach to an end of a beam, and a column mounting portion extending from the body portion and adapted to attach to a column.

The column mounting portion can be a web having one or more bolt holes.

The body portion may have a base portion having first and second opposed edges, a first tab portion extending from the first edge of the base portion at an angle to the base portion, and a second tab portion extending from the second edge of the base portion at an angle to the base portion.

The first and second tab portions may not be parallel to each other.

In another embodiment of the present invention, a method of making a structural support system provides positioning an upstanding column, attaching a beam and column connector to first and second non co-planer surfaces of an end of a beam, and attaching the beam and column connector to the column.

Attaching a beam and column connector to first and second non co-planer surfaces of an end of a beam may provide welding the beam and column connector to the first and second non co-planer surfaces of the end of the beam. Attaching the beam and column connector to the column may provide bolting the beam and column connector to the column.

Embodiments of the present invention may have various features and provide various advantages. Any of the features and advantages of the present invention may be desired, but, are not necessarily required to practice the present invention.

### BRIEF DESCRIPTION OF THE FIGURES

FIG. 1 is a perspective view of a storage rack having beam and column connectors according to the present invention.

FIG. 2 is a perspective view of the beam and column connector of FIG. 1.

FIG. 3 is a perspective view of the beam and column connector of FIG. 2 on a beam.

FIG. 4 is an elevational view of the beam and column connector of FIG. 2.

FIG. 5 is an end view of the beam and column connector of FIG. 4.

FIG. 6 is a top view of the beam and column connector of FIG. 4.

FIG. 7 shows a material blank used to make the beam and column connector of FIG. 2.

FIG. 8 is a top perspective view of another beam and column connector according to the present invention.

FIG. 9 is a bottom perspective view of the beam and column connector of FIG. 8.

FIG. 10 is an elevational view of the beam and column connector of FIGS. 8 and 9.

FIG. 11 is an end view of the beam and column connector of FIG. 10.

FIG. 12 is a top view of the beam and column connector of FIG. 10.

FIG. 13 shows a material blank used to make the beam and column connector of FIGS. 8 and 9.

### DETAILED DESCRIPTION OF THE INVENTION

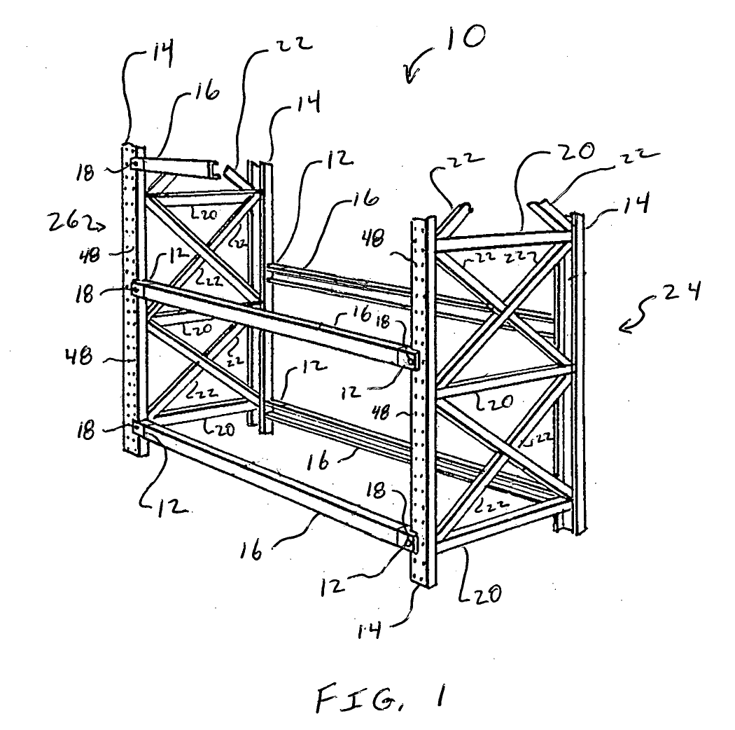

One example of a structural storage rack 10 having beam and column connectors 12 according to the present invention is shown in FIG. 1. The structural storage rack 10 has four upward extending columns 14. A plurality of beams 16 extend between and are connected to opposite columns 14. Each beam 16 has a beam and column connector 12 connected to the beam 16 at both of the opposite ends of the beam 16. The beams 16 are secured to the columns 14 by bolts 18. More specifically, the beam and column connectors 12 are secured to the columns 14 by the bolts 18. The structural storage rack 10 also has horizontal cross-braces 20 and angled cross-braces 22 at storage rack ends 24, 26. The horizontal cross-braces 20 and the angled cross-braces 22 are welded to their respective columns 14. However, the horizontal and angled cross-braces 20, 22 could be secured to the columns 14 by any suitable means.

The illustrated embodiments of the present invention show the beam 16 secured to the column 14 by bolts. However, any suitable mechanism can be used to secure the beam 16 to the column 14, for example, without limitation, welding, rivets, studs, other fasteners and press-fit.

As can be seen while referring to FIGS. 1-3, the beam and column connector 12 can be connected to the column 14 without an inside corner having a radius contacting a square outside corner, such as a square outside corner of the column 14. Accordingly, the connection between the beam and column connector 12 and the column 14 is strong and secure.

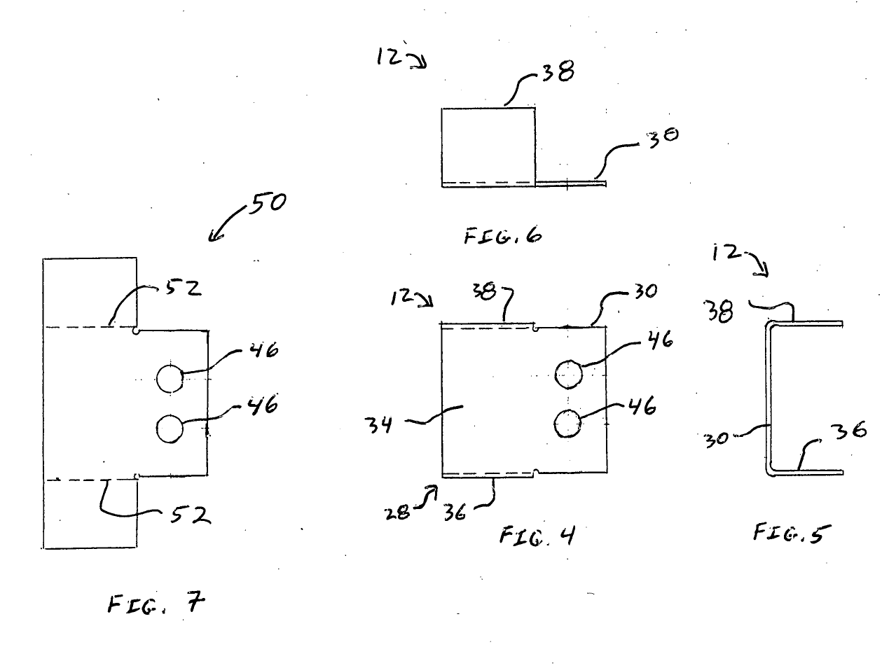

Referring to FIGS. 2-6, the illustrated embodiment of the beam and column connector 12 has a body portion 28 and a column mounting portion 30. The body portion 28 has a shape that conforms to a shape of the beam 16. For example, the beam 32 shown in FIG. 2 is a tube and has a rectangular cross-sectional shape. The body portion 28 of the beam and column connector 12 has a shape which conforms to the outer surface of the beam 32. In other words, the body portion 28 of the beam and column connector 12 has a non-planer surface (e.g., at least two non co-planer surfaces) which conforms to and connects to a corresponding non-planer (e.g., at least two non co-planer surfaces) of the end of the beam 32. The beam and column connector 12 is secured to the beam 32 by welding, for example. More particularly, the body portion 28 of the beam and column connector 12 is welded to the outer surface of the beam 32 at an end of the beam 32. The body portion 28 of the beam and column connector 12 shown in FIGS. 2-6 has a base portion 34 and first and second tab portions 36, 38 extending from opposed edges of the base portion 34. The base portion 34 is welded to a wide face 40 of the beam 32 and the opposite tab portions 36, 38 are welded to opposite side faces 42, 44, respectively, of the beam 32. In this manner, the beam and column connector 12 is securely connected to the beam 32. The beam and column connector 12 shown in FIGS. 2-6 has a shape which conforms to an outer surface of the beam 16. The inside surfaces of the base portion 34 and the tab portions 36, 38 form a non-planer surface or shape. Those inside surfaces can also be considered to be at least two non co-planer surfaces of the beam and column connector 12. The exterior surfaces of the wide face 40 and the opposite side faces 42, 44 of the beam 32 also form a non-planer surface or shape. Those surfaces can also be considered to be at least two non co-planer surfaces of the beam 32. Accordingly, the non-planer shape or surface of the beam and column connector 12 conforms to and is connected to the non-planer shape or surface of the beam 32. One alternative is for the beam and column connector 12 to have a shape which conforms to an inner surface of a beam for connection to such inner beam surface.

The beam and column connector 12 has been described as being welded to the beam 32. However, the present invention contemplates any structure to securely connect the beam and column connector 12 to the beam 32. Some alternative examples include, without limitation, permanently connecting the beam and column connector 12 to the beam 32, removably connecting the beam and column connector 12 to the beam 32, fastening the beam and column connector 12 to the beam 32 with bolts or other fasteners, and bonding the beam and column connector 12 to the beam 32 with an adhesive.

The column mounting portion 30 of the beam and column connector 12 extends from the base portion 34 and has a structure for attachment to the column 14. For example, the column mounting portion 30 can be a web having one or more holes 46 which can be aligned with corresponding holes 48 in the column 14 (refer also to FIG. 1). The bolts 18 are positioned through the holes 46 in the column mounting portion 30 and through the corresponding holes 48 in the column 14 to securely fasten the beam and column connector 12 and the beam 16, 32 to the column 14.

The beam and column connector 12 has been described as being bolted to the column 14. However, the present invention contemplates any structure that securely connects the beam and column connector 12 to the column 14. Some alternative examples include, without limitation, permanently connecting the beam and column connector 12 to the column 14, removably connecting the beam and column connector 12 to the column 14, fastening the beam and column connector 12 to the column 14 with fasteners other than bolts 18, such as rivets, studs and other fasteners, pres-fitting the beam and column connector 12 to the column 14 and bonding the beam and column connector 12 to the column 14 with an adhesive.

Referring now to FIG. 7, a material blank 50 used to make the beam and column connector 12 is shown. The material blank 50 is made of flat steel. The tab portions 36, 38 of the beam and column connector 12 are formed by bending the material blank 50 at bend lines 52. Accordingly, the beam and column connector 12 can be easily and inexpensively manufactured. Furthermore, the beam and column connector 12 can be easily and inexpensively secured to the beam 32. The beam and column connector 12 is, of course, not limited to be made of steel material. Any other material can be used to make the beam and column connector 12 that is suitable for the intended application. For example, without limitation, other metal materials and composite materials could be used to make the beam and column connector 12. Also, the beam and column connector 12 does not have to be formed by bending the flat material blank 50. For example, without limitation, the beam and column connector 12 could be made by hot rolled forming, extrusion, and injection molding.

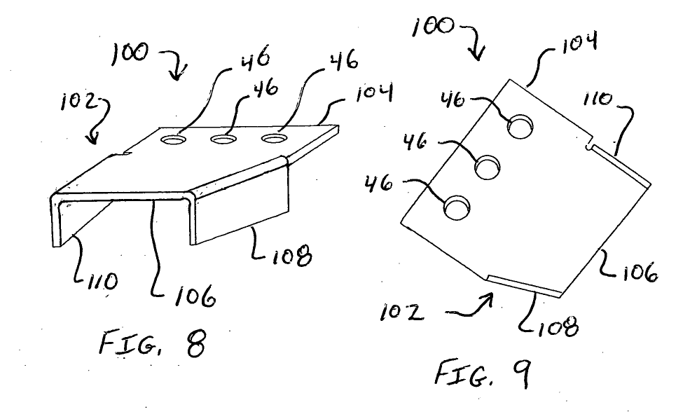

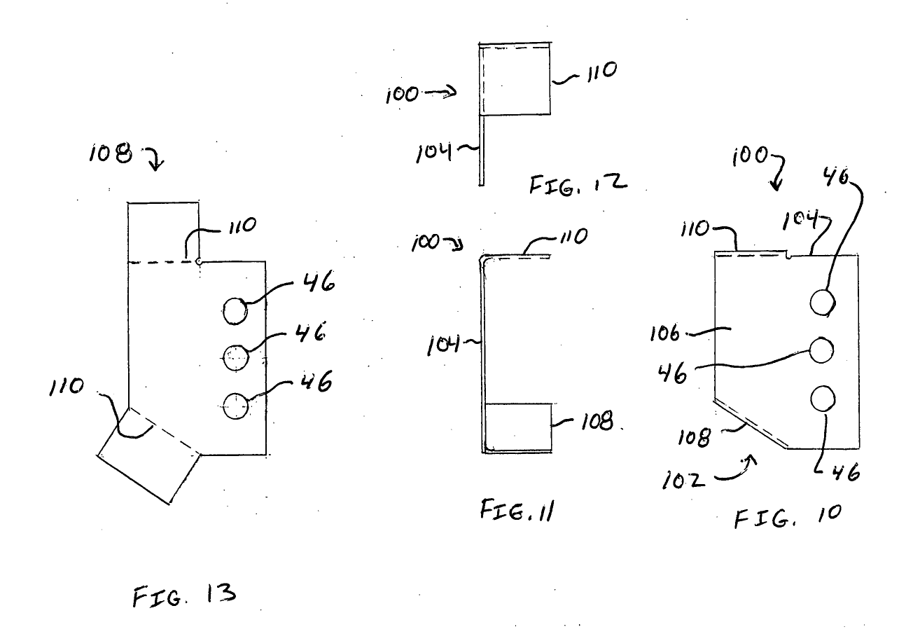

The beam and column connector 12 shown in FIGS. 2-6 has two holes 46 for bolting to the column 14. This provides a strong and secure connection between the beam 16, 32 and the column 14. However, it may be desired to have more than two bolts 18 attaching the beam 16, 32 to the column 14. FIGS. 8-12 show another embodiment of the present invention in which a beam and column connector 100 has more than two holes, e.g., three holes 46, for bolting the beam and column connector 100 to the column 14.

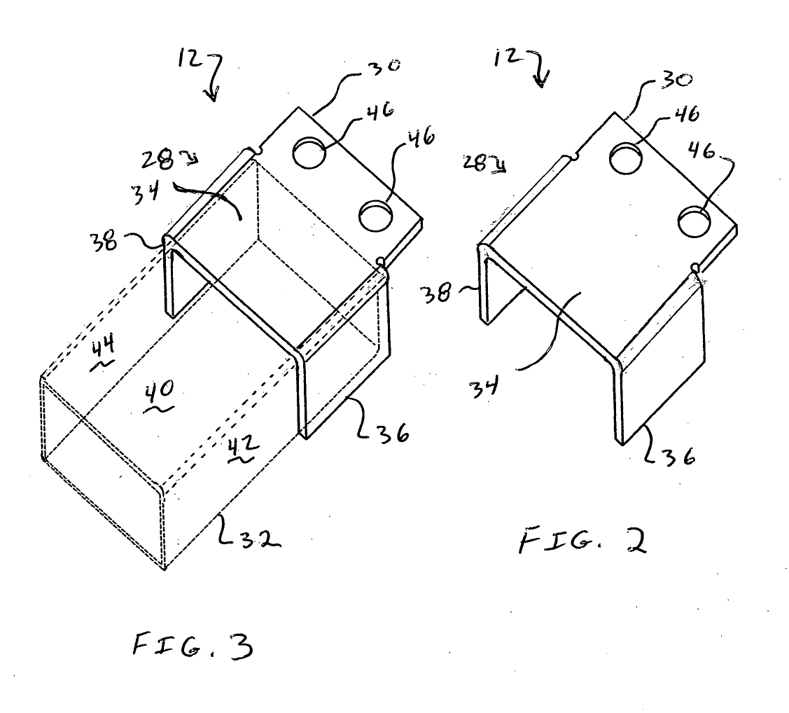

The beam and column connector 100 can be used with the same beam 32 of FIG. 3. The beam and column connector 100 has a body portion 102 and a column mounting portion 104. The body portion 102 has a shape that conforms to a shape of the beam 16, such as the outer surface of the beam 32. Alternatively, the beam and column connector 100 can have a shape that conforms to an inner surface of the beam 32 for connection to such beam inner surface. The beam and column connector 100 is secured to the beam 32 similarly as the beam and column connector 12. The body portion 102 of the beam and column connector 100 has a base portion 106 and first and second tab portions 108, 110 extending from opposed edges of the base portion 106. The base portion 106 has a greater width adjacent the column mounting portion 104 and a narrower width at the end opposite the column mounting portion 104. The narrower width of the base portion 106 opposite the column mounting portion 104 conforms to the outer surface of the beam 32. The tab portion 108 is angled and will be spaced away from the beam 32 at the column mounting portion 104. The beam and column connector 100 is securely attached to the beam 16, 32 and the column 14 in the same manner as the beam and column connector 12 of FIGS. 2-6. However, the column mounting portion 104 of the beam and column connector 100 is larger and provides for more bolts 18 and a larger surface area to contact the column 14 which increases the strength of the connection between the beam 16, 32 and the column 14. The wider column mounting portion 104 can also allow for a wider bolt spread, such as if there are only two bolt holes 46. The wider bolt spread can provide a stronger beam to column connection relative to a narrower bolt spread.

Referring now to FIG. 13, a material blank 108 used to make the beam and column connector 100 is shown. The material blank 108 is made of flat steel. The tab portions 108, 110 of the beam and column connector 100 are formed by bending the material blank 108 at bend lines 110.

The illustrated embodiments of the beam and column connectors 12, 100 have been shown and described as being used with a channel shaped beam 16 of FIG. 1 and a tube-shaped beam having a rectangular cross-section as in FIG. 3. Also, the beam and column connectors 12, 100 have been shown and described as being used with a channel-shaped column 14 as in FIG. 1. However, the beam and column connector of the present invention can be used with a wide variety of beams and columns having a wide variety of shapes. For example, the body portion 28, 102 of the beam and column connectors 12, 100 can be made to have any desired shape or structure to conform to any particular beam. Furthermore, the column mounting portions 30, 104 of the beam and column connectors 12, 100 can be made to have any desired shape or structure for attachment to any desired column. Also, FIG. 1 shows two beam and column connectors 12 attached to opposite ends of the beam 16 such that the opposite ends of the beam 16 are mounted to two spaced apart columns 14, 14. However, the beam and column connectors according to the present invention can be used with cantilever beams. One beam and column connector can be connected to one end of the beam 16 and to the column 14. The opposite end of the beam is free such that the beam is cantilevered from the column.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A structural support system, comprising:
an upward extending column;
a beam having an end adjacent the column; and
a beam and column connector having a body portion having a non-planer shape conforming to and attached to a non-planer surface of the end of the beam, the beam and column connector having a column mounting portion extending from the body portion and connected to the column.

2. The structural support system according to claim 1, wherein the body portion of the beam and column connector is welded to the end of the beam.

3. The structural support system according to claim 2, wherein the column mounting portion of the beam and column connector is a web having a bolt hole and the beam and column connector is bolted to the column.

4. The structural support system according to claim 1, wherein the non-planer shape of the beam and column connector has at least two non co-planer surfaces which conform to and connect to either an outer surface of the beam or an inner surface of the beam.

5. The structural support system according to claim 1, wherein the column mounting portion has a width about the same as a cross-sectional width of the beam.

6. The structural support system according to claim 1, wherein the column mounting portion has a width greater than a cross-sectional width of the beam.

7. The structural support system according to claim 6, wherein the body portion of the beam and column connector has a width adjacent the column mounting portion which is wider than the cross-sectional width of the beam, and wherein the width of the body portion narrows at an end opposite the column mounting portion.

8. The structural support system according to claim 1, wherein the body portion of the beam and column connector comprises:
a base portion having first and second opposed edges;
a first tab portion extending from the first edge of the base portion at an angle to the base portion; and
a second tab portion extending from the second edge of the base portion at an angle to the base portion.

9. The structural support system according to claim 8, wherein the first and second tab portions are not parallel to each other.

10. The structural support system according to claim 1, wherein the end of the beam is a first end and the beam has a second end opposite the first end; and wherein the column is a first column, the structural support system further comprising:
another beam and column connector having a body portion attached to the second end of the beam and a column mounting portion extending from the body portion and connected to another column spaced away from the first column.

11. The structural support system according to claim 10,
wherein the body portion of each beam and column connector is welded to its respective first or second end of the beam; and
wherein the column mounting portion of each beam and column connector is a web having a bolt hole and is bolted to its respective first or second column.

12. A beam and column connector for a structural support system, comprising:
a body portion having a non-planer surface adapted to attach to an end of a beam; and
a column mounting portion extending from the body portion and adapted to attach to a column.

13. The beam and column connector according to claim 12, wherein the column mounting portion is a web having a bolt hole.

14. The beam and column connector according to claim 13, wherein the body portion comprises:
a base portion having first and second opposed edges;
a first tab portion extending from the first edge of the base portion at an angle to the base portion; and
a second tab portion extending from the second edge of the base portion at an angle to the base portion.

15. The beam and column connector according to claim 14, wherein the first and second tab portions are not parallel to each other.

16. A method of making a structural support system, comprising:
positioning an upstanding column;
attaching a beam and column connector to first and second non co-planer surfaces of an end of a beam; and
attaching the beam and column connector to the column.

17. The method of making a structural support system according to claim 16, wherein
attaching a beam and column connector to first and second non co-planer surfaces of an end of a beam comprises welding the beam and column connector to the first and second non co-planer surfaces of the end of the beam; and
attaching the beam and column connector to the column comprises bolting the beam and column connector to the column.
